(19) United States
(12) Patent Application Publication
(10) Pub. No.: US 2014/0184586 A1
(43) Pub. Date: Jul. 3, 2014

(54) DEPTH OF FIELD VISUALIZATION

(71) Applicant: INTERNATIONAL BUSINESS MACHINES CORPORATION, Armonk, NY (US)

(72) Inventors: John F. Kelley, Clarkesville, GA (US); Todd Seager, Orem, UT (US)

(73) Assignee: International Business Machines Corporation, Armonk, NY (US)

(21) Appl. No.: 13/732,577

(22) Filed: Jan. 2, 2013

(51) Int. Cl. G06T 15/00

(52) U.S. Cl. 345/419

(57) ABSTRACT

In a method for visualizing depth of field, a computing device determines a distance value for each respective pixel of a plurality of pixels of a digital image based on a distance between subject matter depicted in the respective pixel and an imaging device integrated with the computing device. The computing device determines a depth of field of the digital image. The computing device compares the depth of field of the digital image to the distance value for each respective pixel to determine a first set of pixels of the plurality of pixels having distance values outside the depth of field and a second set of pixels of the plurality of pixels having distance values inside the depth of field. The computing device indicates the first set of pixels in a user interface.

### FIELD OF THE INVENTION

The present invention relates generally to the field of photography, and more particularly to the visualization of depth of field.

### BACKGROUND OF THE INVENTION

Depth of field is the part of a still image or video that is “in focus”, as rendered by the optical elements of an imaging system. More particularly, depth of field is the distance between the nearest and farthest objects in a scene that appear acceptably sharp in an image. Professional photographers use depth of field to isolate subjects for visual effect, or expand depth of field to bring additional compositional elements or a large subject (relative to optical factors) into focus. Depth of field is used by photographers as it can be adjusted so that all or most of the image is in focus, or it can be adjusted to blur foregrounds or backgrounds to isolate the subject (called bokeh). The aperture of the device (lens opening) controls the depth of field; the smaller the opening, the greater the depth of field. Distance to the subject (subject in focus), focal length of the lens, sensor size and pixel size also affect depth of field, as calculated from the circle of confusion.

Depth of field varies greatly. Depth of field is considered the most valuable creative tool when capturing images or video and can be accurately calculated. However, finding the correct aperture to meet creative expectations is one of trial and error, even for the most experienced photographer or videographer. Many variables affect imaging depth of field, making precision difficult to achieve without time or tools.

### SUMMARY

Aspects of an embodiment of the present invention disclose a method, computer program product, and computing system for visualizing depth of field. A computing device determines a distance value for each respective pixel of a plurality of pixels of a digital image based on a distance between subject matter depicted in the respective pixel and an imaging device integrated with the computing device. The computing device determines a depth of field of the digital image. The computing device compares the depth of field of the digital image to the distance value for each respective pixel to determine a first set of pixels of the plurality of pixels having distance values outside the depth of field and a second set of pixels of the plurality of pixels having distance values inside the depth of field. The computing device indicates the first set of pixels in a user interface.

### BRIEF DESCRIPTION OF THE SEVERAL VIEWS OF THE DRAWINGS

FIG. 1 is a functional block diagram of an image capturing device, in accordance with one embodiment of the present invention.

FIG. 2A is an exemplary view of a user interface for an image capturing program of the image capturing device of FIG. 1, in accordance with one embodiment of the present invention.

FIG. 2B is an exemplary view of the user interface as affected by a depth of field program for visualizing the depth of field in an image captured by the image capturing program, in accordance with one embodiment of the present invention.

FIG. 3 is a flowchart depicting the steps of the depth of field program, in accordance with one embodiment of the present invention.

### DETAILED DESCRIPTION

Depth of field is the distance between the nearest and farthest objects in a scene that appear acceptably sharp in an image and is considered the most valuable creative tool when capturing images or videos. Although depth of field can be accurately calculated, it is often challenging for photographer's to determine the appropriate settings required to meet creative expectations, thus making it a process of trial and error. Embodiments of the present invention recognize that it is particularly difficult for the photographer to see the depth of field of a captured digital image on small, low resolution displays integrated with most imaging devices, such as digital cameras. Photographers are unable to accurately view depth of field on smaller displays attached to the imaging device without first zooming, or displaying the photograph on another display. The present invention utilizes a computer program to visualize depth of field by overlaying or blurring the parts of the captured digital image that are out of the depth of field, providing the photographer with immediate visual feedback.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

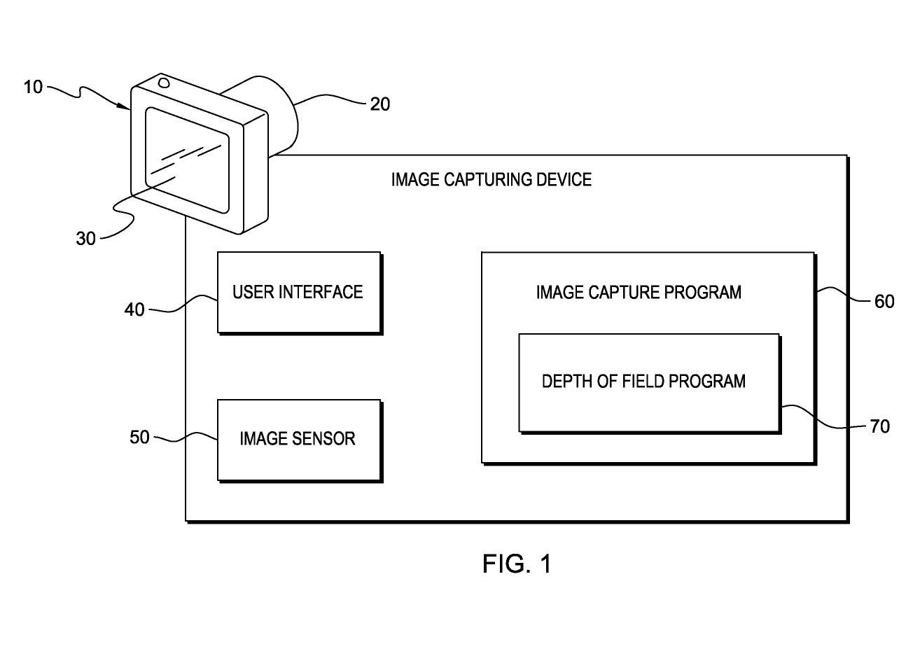

The present invention will now be described in detail with reference to the Figures. FIG. 1 is a functional block diagram of image capturing device 10, in accordance with one embodiment of the present invention. FIG. 1 provides only an illustration of one embodiment and does not imply any limitations with regard to the environments in which different embodiments may be implemented.

In the depicted embodiment, image capturing device 10 is a computing device integrated with an imaging device. For example, image capturing device 10 can be a digital camera, such as a digital single lens reflex camera (dSLR), having computer processing capabilities or, alternatively, an imaging device in communication with a separate distinct computing device. In other embodiments, image capturing device 10 may be a digital video camera, a computer with an integrated digital camera, a smart phone equipped with a digital camera, or any programmable electronic device capable of capturing and displaying digital images. Digital images may be still photographs or moving images such as videos or movies. Image capturing device 10 includes optical lens 20, display 30, user interface 40, image sensor 50, image capture program 60, and depth of field program 70.

Optical lens 20 is integrated with image capturing device 10. In one embodiment, optical lens 20 is an interchangeable dSLR lens. For example, optical lens 20 may be a 30 mm interchangeable dSLR lens. In another embodiment, optical lens 20 may be permanently fixed to image capturing device 10. For example, optical lens 20 is permanently fixed when image capturing device 10 is a digital point and shoot camera. Optical lens 20 operates to focus light onto image sensor 50.

The aperture (not shown) is the opening through which light travels through optical lens 20 and into image capturing device 10. The aperture may be located in different spots within optical lens 20. For example, the aperture may be a ring or other fixture that holds an optical element in place, or it may be a diaphragm placed in the optical path to limit the amount of light that emitted through the lens. The aperture may be adjusted to control the amount of light entering image capturing device 10.

The lens focal length of optical lens 20 may be adjusted by the operator of image capturing device 10 if the optical lens is not a fixed focal length lens. The lens focal length is the distance over which the rays of light are focused on a focal point. The focal point is the point at which the rays of light converge and are focused. Adjusting the lens focal length of optical lens 20 will also adjust the f-number of optical lens 20, which is the ratio of the lens focal length to the diameter of the aperture. The f-number is set in order to adjust the aperture diameter in order to control the amount of light entering imaging device 10. When written, the f-number is usually preceded by f/. Therefore, an f-number of 4 is written as f/4. For example, if optical lens 20 is a 100 mm focal length lens with an f-number setting of f/4, optical lens 20 will have an aperture diameter of 25 mm.

Display 30 is connected to image capturing device 10. In one embodiment, display 30 is a liquid crystal display (LCD) fixed to image capturing device 10. In another embodiment, display 30 is a display monitor connected to a computer with an integrated digital camera. In another embodiment, display 30 is a display monitor connected to a network, or LAN. In yet another embodiment, display 30 is a monitor attached to image capturing device 10 via a cable. Display 30 operates to display a digital image captured by image capturing device 10. A digital image is comprised of a set of pixels. In one embodiment, a digital image may be a still image. In another embodiment, a digital image may be a digital video.

User interface 40 operates on image capturing device 10 and works in conjunction with display 30 to visualize content such as images captured by image capturing device 10. User interface 40 may comprise one or more interfaces such as an operating system interface and application interfaces. In one embodiment, user interface 40 comprises an interface to image capture program 60 and depth of field program 70. In one embodiment, user interface 40 receives an image captured by image capturing program 60 and sends the image to display 30.

Image sensor 50 is integrated with image capturing device 10. Image sensor 50 is a detector that converts an optical image into an electronic signal. The electrical signals are quantized by an analog-to-digital (A/D) converter (not shown). In one embodiment, image sensor 50 may be a charge-coupled device (CCD) sensor. In another embodiment, image sensor 50 may be a complementary metal-oxide semiconductor (CMOS) sensor or another type of sensor. In yet another embodiment, image sensor 50 could be a specialized sensor for medical imaging.

In one embodiment, light passes through optical lens 20 and reaches image sensor 50, which contains an array of pixel sensors that are evenly distributed over image sensor 50. A pixel sensor may be comprised of a semiconductor material that absorbs light photons and generates electronic signals. In one embodiment, image sensor 50 may also contain autofocus pixel sensors. The autofocus pixel sensors may be an array that is arranged in various patterns. In another embodiment, the autofocus pixel sensors may be contained on a sensor that is separate from image sensor 50.

Image capture program 60 is a standard image capture program. For example, image capture program 60 is a program operating on a digital camera, such as Nikon® Scene Recognition System. In one embodiment, image capture program 60 receives and processes electronic signals from image sensor 50. Image capture program 60 sends the processed image to user interface 40 for display on display 30.

In one embodiment, image capture program 60 also manages autofocus capabilities of image capturing device 10. Autofocus capabilities utilize one or more autofocus pixel sensors to determine if the image is in focus and electromechanically adjusts the focus of image capturing device 10 if the image is not in focus. The user may use user interface 40 to operate image capture program 60 to select one or more focus points to set the photographer's focus point in the field of view of image capturing device 10. A focus point is a location in the field of view of image capture device 10 associated with an autofocus pixel sensor. Image capture program 60 then determines if the subject matter at the single focus point is in focus. If the subject matter at the single focus point is not in focus image capture program 60 electromechanically adjusts the focus until the subject matter is in focus.

If the autofocus program utilizes active autofocus, image capturing program 60 may use ultrasonic waves or triangulation of infrared light to determine the distance between the subject and sensor 50. Active autofocus is a type of autofocus that determines correct focus by measuring distance to the subject independently of the optical system. In one embodiment, an ultrasonic wave detector (not shown) may be used to determine distance. In another embodiment, an infrared light detector (not shown) may be used to determine distance. In yet another embodiment, another method may be used to determine distance. If the autofocus program utilizes passive autofocus, image capture program 60 may use phase detection or contrast measurement to determine focus. Passive autofocus is a type of autofocus that determines correct focus by performing a passive analysis of the image that is entering the optical system. In one embodiment, image capture program 60 may be able to detect motion of the subject matter toward or away from the camera while maintaining focus on the subject matter.

In one embodiment, phase detection may also determine distance between the subject matter at a focus point and an autofocus pixel sensor associated with the focus point. Phase detection may function in a way similar to a rangefinder, which is a focusing mechanism that allows the user to measure the distance to the subject matter. A rangefinder shows two identical images. One image moves when a calibrated wheel on the image capturing device is turned. After the two images overlap and fuse into one, the distance is read off the calibrated wheel. For example, when utilizing phase detection imaging device 10 contains a beam splitter (not shown) that captures light from opposite sides of the lens and diverts light to autofocus sensors located separately from image sensor 50. This generates two separate images which are compared for light intensity and separation error in order to determine whether the image is in or out of focus. During this comparison, phase detection is used to determine the distance between the subject matter at a focus point to the associated autofocus pixel sensor. For example, digital cameras measure distance to the subject matter electronically.

Depth of field program 70 operates to visualize the depth of field of an image captured by image capture program 60. In one embodiment, depth of field program 70 determines the depth of field of the captured image based on image data, which includes data required to calculate depth of field such as aperture diameter, focal length of optical lens 20, and the distance between the subject at a focus point to an autofocus pixel sensor associated with the focus point by using the image capture program's autofocus capabilities. Image data also includes distances to a plurality of focus points. Depth of field program 70 causes the depth of field to be displayed in user interface 40 of image capturing device 10. As depicted, depth of field program 70 is a sub-program or routine of image capture program 60. In another embodiment, depth of field program 70 may be an independent program in communication with image capture program 60.

In one embodiment, depth of field program 70 overlays a mask of varying transparency over an image in order to distinguish between areas that are inside and outside the depth of field. For example, depth of field program 70 overlays an opaque mask for areas that are well outside the depth of field and a semi-transparent mask for focus points close to the depth of field. Areas inside the depth of field surrounding the chosen focus point are not masked. In another embodiment, depth of field program 70 may overlay a mask of varying colors or patterns over an image in order to distinguish between areas that are inside and outside the depth of field. For example, depth of field program 70 may overlay a blue mask for areas that are well outside the dept of field and a red mask for focus points close to the depth of field. In this embodiment, depth of field program 70 may overlay areas inside the depth of field with a yellow mask. In yet another embodiment, depth of field program 70 exaggerates bokeh of the image in order to visualize depth of field. Exaggeration of bokeh would increase as the display size decreases.

Image capturing device 10 may include internal and external components as depicted in further detail with respect to FIG. 4.

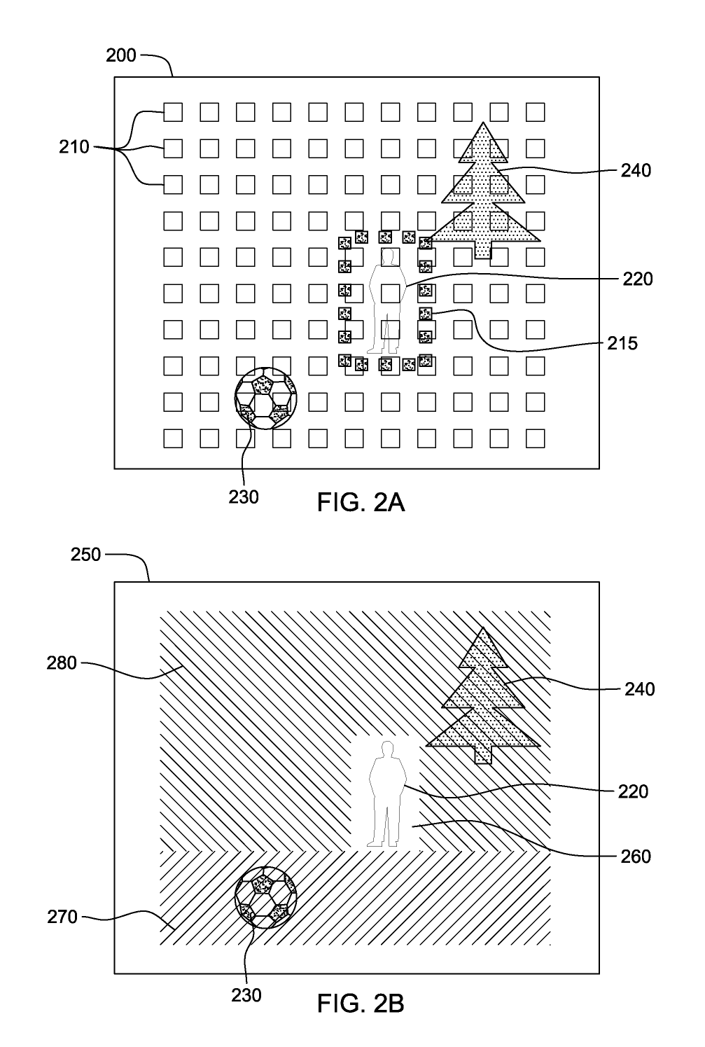

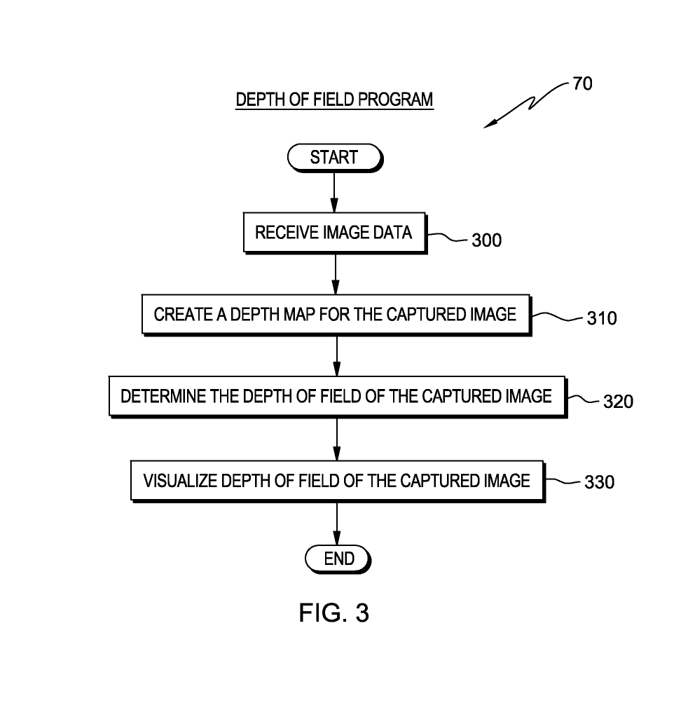

FIGS. 2A and 2B depict exemplary views of the user interface for image capture program 60 and depth of field program 70, in accordance with one embodiment of the present invention. A user interface 200 of FIG. 2A and a user interface 250 of FIG. 2B are each an example of user interface 40 of FIG. 1 and may allow a user to see displayed content from image capture program 60 and depth of field program 70.

FIG. 2A depicts a display of user interface 200 before depth of field is displayed. User interface 200 contains an image received from image capture program 60. The image includes subject 220 and objects 230 and 240. Focus points 210 are locations in the field of view of image capturing device 10 each associated with an autofocus pixel sensor. In one embodiment, the user may select a single focus point via user interface 200. In another embodiment, the user may select a plurality of focus points via user interface 200. Selected focus points 215 are focus points selected by the user to be in focus. Subject 220 is the object that is at the focus points selected by the user. Subject 220 is in focus in the image displayed on display 30 of image capturing device 10. Foreground object 230 is an out of focus object in the foreground of the image. Background object 240 is an out of focus object in the background of the image.

FIG. 2B depicts a display of user interface 250 after depth of field is displayed. User interface 250 contains an image received from image capture program 60. The image includes subject 220 and objects 230 and 240. Subject 220 is the subject of the image, and the subject is in focus in the image displayed on display 30. Foreground object 230 is an out of focus object in the foreground of the image. Background object 240 is an out of focus object in the background of the image. Focus area 260 is the in focus area around object 220 that in the depth of field. Foreground overlay 270 is a mask over the out of focus area in the foreground of the image that is out of the depth of field. Background overlay 280 is a mask over the out of focus area in the background that is out of the depth of field.

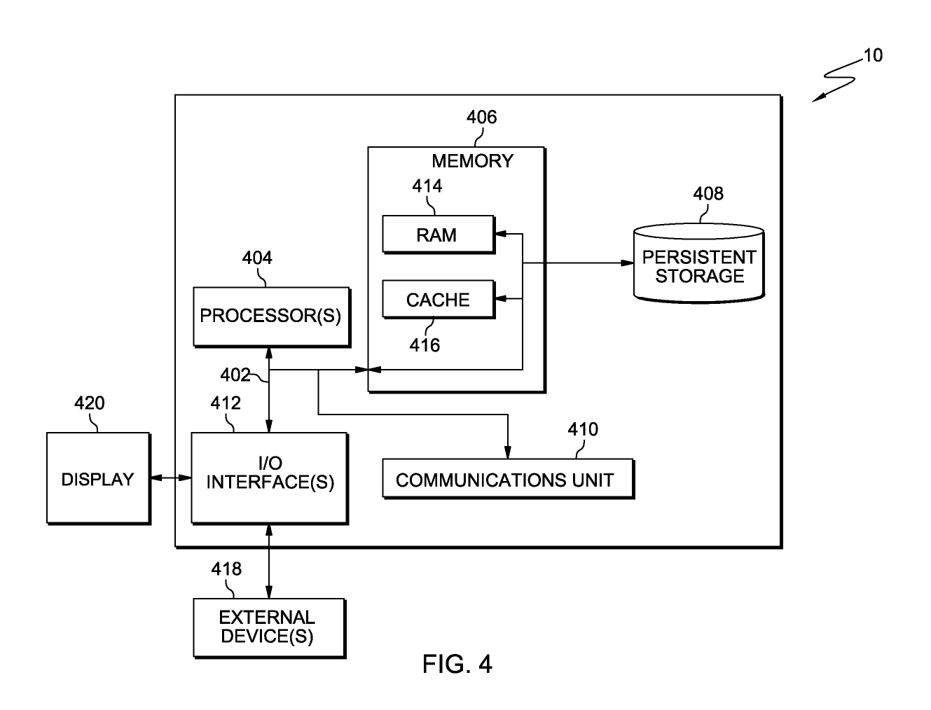

FIG. 3 is a flowchart depicting operational steps of depth of field program 70 for visualizing the depth of field of a captured image, in accordance with an embodiment of the present invention.

In one embodiment, the user selects the photographer's focus point in the field of view. In one embodiment, initially, light passes through lens 20. Image sensor 50 absorbs light, converts it into an electronic signal, and sends the signal to image capture program 60. Image capture program 60 receives the electronic signal from image sensor 50. Image capture program 60 adjusts autofocus to bring the subject matter at the photographer's focus point into focus. Image capture program 60 determines a distance between subject matter at a focus point and an autofocus pixel sensor associated with the focus point for each focus point in a plurality of focus points. In one embodiment, image capture program 60 determines image data, which includes data required to calculated depth of field such as aperture diameter, focal length of optical lens 20, and the distance between the subject matter at the photographer's focus point and the autofocus pixel sensor associated with the photographer's focus point by using the image capture program's autofocus capabilities. Image data also includes the distance between subject matter at a focus point and an autofocus pixel sensor associated with the focus point for each focus point in a plurality of focus points. In one embodiment, image capture program 60 sends some or all of the image data to depth of field program 70.

In one embodiment, image capture program 60 causes the captured image to be displayed in user interface 40. In another embodiment, image capture program 60 sends the captured image to depth of field program 70.

In step 300, depth of field program 70 receives image data. In one embodiment, depth of field program 70 receives image data from image capture program 60. In another embodiment, depth of field program 70 may access the autofocus capabilities of image capture program 60 and the depth of field program determines image data. Image data includes data required to calculate depth of field such as aperture diameter, focal length of optical lens 20, and the distance between the subject matter at the photographer's focus point and the autofocus pixel sensor associated with the photographer's focus point.

In step 310, depth of field program 70 creates a depth map for the captured image. In one embodiment, a depth map represents pixels of the captured image and the distances associated with each pixel to the autofocus pixel sensor associated with each pixel. Each focus point of the plurality of focus points is associated with one or more pixels of the captured image. Each distance in the image data is associated with a focus point. In one embodiment, depth of field program 70 determines the average of the distances for the pixels of the captured image that are not associated with a focus point. For example, depth of field program 70 determines the average of the distances associated with two adjacent focus points, and assigns the average distance value to the pixels between the two adjacent focus points that are not associated with a focus point. In another embodiment, depth of field program 70 determines graduated distances for pixels that are not associated with a focus point. For example, depth of field program 70 determines the distances for two adjacent focus points and assigns graduated distance values to the pixels between the two adjacent focus points that are not associated with a focus point.

In step 320, depth of field program 70 determines the depth of field for the image captured by program 60. In one embodiment, depth of field program 70 determines the depth of field for a captured image based on the image data. Image data includes aperture diameter, focal length of optical lens 20, and the distance between the subject matter at the photographer's focus point to the autofocus pixel sensor associated with the photographer's focus point. For example, depth of field program 70 determines the depth of field for the captured image by using a known algorithm to calculate depth of field. Depth of field includes a range of distances from the focus point selected by the photographer.

In step 330, depth of field program 70 visualizes the depth of field of the captured image. In one embodiment, depth of field program 70 determines which pixels of the captured image are in the depth of field. Depth of field program 70 compares the range of distances in the depth of field to the distance values assigned to each pixel in the depth map. If a pixel falls into the range of distances in the depth of field, the pixel is considered to be in the depth of field. If a pixel is associated with a distance further than the depth of field, the pixel is considered to be beyond the depth of field in the background of the captured image. Depth of field program 70 masks pixels that are beyond the depth of field with an overlay. Depth of field program 70 does not mask pixels that are in the depth of field. If a pixel is associated with a distance closer than the depth of field, the pixel is considered to be outside the depth of field and in the foreground of the captured image. Depth of field program 70 masks pixels that are closer than the depth of field with an overlay.

In one embodiment, compositional elements that are “in focus” or within the depth of field are not masked. Elements outside the plane of focus are masked by a progressively opaque mask, with the points furthest from the plane of focus of the lens being the least transparent. In another embodiment, the elements furthest from the plane of focus of the lens are blurred, as this depth map simulates how the final image will appear on a larger display. In yet another embodiment, elements in the background are masked by a pattern or color and elements in the foreground are masked by a different pattern or color.

In one embodiment, depth of field program 70 causes the depth of field of the captured image to be displayed on user interface 40. The mask visualized across the image shown on display 30 of image capturing device 10 helps the user visualize the locations of objects in the image with respect to the subject of the digital image and previews the digital image so the user can clearly see which elements are in focus and which elements are out of focus. Some or all parts of the digital image may be masked. In one embodiment, depth of field program 70 sends an indication of which pixels to overlay and the type of mask to use to user interface 40. In another embodiment, depth of field program 70 sends an indication of which pixels to overlay and the type of mask to image capture program 60 and image capture program 60 sends the indication to user interface 40.

FIG. 4 depicts a block diagram of components of image capturing device 10 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Image capturing device 10 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

User interface 40, image capture program 60, and depth of field program 70 are stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other servers. In these examples, communications unit 410 includes one or more network interface cards. Communications unit 410 may provide communications through the use of either or both physical and wireless communications links. User interface 40, image capture program 60, and depth of field program 70 may be downloaded to persistent storage 408 through communications unit 410.

I/O interface(s) 412 allows for input and output of data with other devices that may be connected to image capturing device 10. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., user interface 40, image capture program 60, and depth of field program 70, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for visualizing depth of field of a digital image, the method comprising the steps of:
a computing device determining a distance value for each respective pixel of a plurality of pixels of a digital image based on a distance between subject matter depicted in the respective pixel and an imaging device integrated with the computing device;
the computing device determining a depth of field of the digital image; and
the computing device comparing the depth of field of the digital image to the distance value for each respective pixel to determine a first set of pixels of the plurality of pixels having distance values outside the depth of field and a second set of pixels of the plurality of pixels having distance values inside the depth of field; and
the computing device indicating the first set of pixels in a user interface.

2. The method of claim 1, wherein the step of the computing device indicating the first set of pixels in a user interface comprises the computing device overlaying a first mask over the first set of pixels having distance values outside the depth of field in the user interface.

3. The method of claim 2, wherein the first mask varies in transparency.

4. The method of claim 1, wherein the step of the computing device indicating the first set of pixels in a user interface comprises the computing device blurring the first set of pixels having distance values outside the depth of field in the user interface.

5. The method of claim 1, further comprising the steps of:
the computing device determining a first subset of pixels of the first set of pixels having distance values less than a lowest distance range value of the depth of field; and
the computing device determining a second subset of pixels of the first set of pixels having distance values greater than a highest distance range value of the depth of field.

6. The method of claim 5, further comprising the steps of:
the computing device overlaying a second mask over the first subset of pixels of the first set of pixels having distance values less than a lowest distance range value of the depth of field; and
the computing device overlaying a third mask over the second subset of pixels of the first set of pixels having distance values greater than a highest distance range value of the depth of field.

7. A computer program product for visualizing depth of field of a digital image, the computer program product comprising:
one or more computer-readable storage media and program instructions stored on the one or more computer-readable storage media, the program instructions comprising:
program instructions to determine a distance value for each respective pixel of a plurality of pixels of a digital image based on a distance between subject matter depicted in the respective pixel and an imaging device integrated with the computing device;
program instructions to determine a depth of field of the digital image; and
program instructions to compare the depth of field of the digital image to the distance value for each respective pixel to determine a first set of pixels of the plurality of pixels having distance values outside the depth of field and a second set of pixels of the plurality of pixels having distance values inside the depth of field; and
program instructions to indicate the first set of pixels in a user interface.

8. The computer program product of claim 7, wherein the program instructions to indicate the first set of pixels in a user interface comprise program instructions to overlay a first mask over the first set of pixels having distance values outside the depth of field in the user interface.

9. The computer program product of claim 8, wherein the first mask varies in transparency.

10. The computer program product of claim 7, wherein the program instructions to indicate the first set of pixels in a user interface comprise program instructions to blur the first set of pixels having distance values outside the depth of field in the user interface.

11. The computer program product of claim 7, further comprising:
program instructions stored on the one or more computer-readable storage media, to determine a first subset of pixels of the first set of pixels having distance values less than a lowest distance range value of the depth of field; and
program instructions stored on the one or more computer-readable storage media, to determine a second subset of pixels of the first set of pixels having distance values greater than a highest distance range value of the depth of field.

12. The computer program product of claim 11, further comprising:
program instructions stored on the one or more computer-readable storage media, to overlay a second mask over the first subset of pixels of the first set of pixels having distance values less than a lowest distance range value of the depth of field; and
program instructions stored on the one or more computer-readable storage media, to overlay a third mask over the second subset of pixels of the first set of pixels having distance values greater than a highest distance range value of the depth of field.

13. A computer system for visualizing depth of field of a digital image, the computer system comprising:
one or more computer processors;
one or more computer-readable storage media;
program instructions stored on the computer-readable storage media for execution by at least one of the one or more processors, the program instructions comprising:
program instructions to determine a distance value for each respective pixel of a plurality of pixels of a digital image based on a distance between subject matter depicted in the respective pixel and an imaging device integrated with the computing device;
program instructions to determine a depth of field of the digital image; and
program instructions to compare the depth of field of the digital image to the distance value for each respective pixel to determine a first set of pixels of the plurality of pixels having distance values outside the depth of field and a second set of pixels of the plurality of pixels having distance values inside the depth of field; and
program instructions to indicate the first set of pixels in a user interface.

14. The computer system of claim 13, wherein the program instructions to indicate the first set of pixels in a user interface comprise program instructions to overlay a first mask over the first set of pixels having distance values outside the depth of field in the user interface.

15. The computer system of claim 14, wherein the first mask varies in transparency.

16. The computer system of claim 13, wherein the program instructions to indicate the first set of pixels in a user interface comprise program instructions to blur the first set of pixels having have distance values outside the depth of field in the user interface.

17. The computer system of claim 13, further comprising:
program instructions stored on the computer-readable storage media for execution by at least one of the one or more processors, to determine a first subset of pixels of the first set of pixels having distance values less than a lowest distance range value of the depth of field; and
program instructions stored on the computer-readable storage media for execution by at least one of the one or more processors, to determine a second subset of pixels of the first set of pixels having distance values greater than a highest distance range value of the depth of field.

18. The computer system of claim 17, further comprising:
program instructions stored on the computer-readable storage media for execution by at least one of the one or more processors, to overlay a second mask over the first subset of pixels of the first set of pixels having distance values less than a lowest distance range value of the depth of field; and
program instructions stored on the computer-readable storage media for execution by at least one of the one or more processors, to overlay a third mask over the second subset of pixels of the first set of pixels having distance values greater than a highest distance range value of the depth of field.
